(19) United States
(12) Patent Application Publication
(10) Pub. No.: US 2025/0240569 A1
(43) Pub. Date: Jul. 24, 2025

(54) SPEAKER SYSTEM

(71) Applicant: ALPS ALPINE CO., LTD., Tokyo (JP)

(72) Inventors: Haruki UESUGI, Fukushima (JP); Ryo ITO, Fukushima (JP)

(21) Appl. No.: 18/986,136

(22) Filed: Dec. 18, 2024

(30) Foreign Application Priority Data
Jan. 22, 2024 (JP) 2024-007374

(51) Int. Cl. H04R 3/14; H04R 1/26

(52) U.S. Cl. CPC H04R 3/14; H04R 1/26; H04R 2430/01

(57) ABSTRACT

A speaker system includes an output sound generator configured to output a sound to be output; a speaker array that includes a plurality of speakers; and a speaker driver configured to extract a plurality of frequency components having different frequencies from the sound that is output from the output sound generator, and selectively drive one or more of the plurality of speakers in accordance with signals of the plurality of frequency components. The speaker driver is configured to input the plurality of frequency components to the one or more of the plurality of speakers in accordance with widths of directivity of the plurality of frequency components.

### CROSS-REFERENCE TO RELATED APPLICATIONS

The present application is based on and claims priority to Japanese Patent Application No. 2024-007374 filed on Jan. 22, 2024, the entire contents of which are hereby incorporated by reference.

### BACKGROUND

### 1. Field of the Invention

The present disclosure relates to a speaker system in which a plurality of speakers are combined together.

### 2. Description of the Related Art

A speaker system in which directivity with respect to signals in a wide frequency band is controlled by combining a plurality of speakers, is known (see, for example, Japanese Unexamined Patent Application Publication No. 2019-68398). According to this speaker system, by setting characteristics of filters corresponding to the plurality of speakers, it is possible to achieve directivity different between low-frequency components and high-frequency components.

The above-described speaker system, disclosed in Japanese Unexamined Patent Application Publication No. 2019-68398, can output sounds of various frequency components, such as low-frequency components, high-frequency components, and the like, to listeners (users) located at specific places. However, in general, the width of the directivity of a sound output from a speaker changes in accordance with the frequency of the sound. Specifically, as the frequency of a sound becomes higher, the directivity becomes narrower, whereas as the frequency of a sound becomes lower, the directivity becomes wider. Therefore, for example, when a plurality of listeners are located laterally widely with respect to a position facing the speaker, the low-frequency component of the sound reaches all of the listeners, but the high-frequency component may reach only one of the listeners, and the other listeners may not be able to hear the sound sufficiently.

The present disclosure provides a speaker system in which a plurality of listeners located at specific places can hear sounds in a wide frequency range, i.e., a low-frequency sound to a high-frequency sound.

### SUMMARY

According to an aspect of the present disclosure, a speaker system of the present disclosure includes: an output sound generator configured to output a sound to be output; a speaker array that includes a plurality of speakers; and a speaker driver configured to extract a plurality of frequency components having different frequencies from the sound that is output from the output sound generator, and selectively drive one or more of the plurality of speakers in accordance with signals of the plurality of frequency components. The speaker driver is configured to input the plurality of frequency components to the one or more of the plurality of speakers in accordance with widths of directivity of the plurality of frequency components.

By switching speakers to be driven for each frequency component, it is possible to widen directivity of emitted sounds, which becomes narrower as the frequency becomes higher in the case of being emitted from the same number of speakers. Thus, a plurality of listeners located at specific places can hear sounds in a wide frequency range, i.e., a low-frequency sound to a high-frequency sound.

Also, it is desirable that the above-described high-frequency components correspond to one or more of the speakers disposed in a narrow range, and the above-described low-frequency components correspond to the plurality of speakers disposed in a wide range. In addition, it is desirable that the above-described high-frequency components correspond to a small number of the speakers disposed in a narrow range, and the above-described low-frequency components correspond to a large number of the speakers disposed in a wide range. In this manner, when the range of disposed speakers and the number of speakers are varied for each frequency component, it is possible to desirably set the width of directivity for each frequency band.

Also, it is desirable to further include a gain adjuster configured to adjust an output level of the speaker array in accordance with at least a part of the plurality of frequency components described above. Thus, when a sound is emitted from different numbers of speakers in accordance with each frequency component, it is possible to eliminate the difference in the output level for each frequency component.

Also, it is desirable that the speakers are the same in number for each of the plurality of frequency components described above. This facilitates elimination of the difference in the output level for each frequency component.

Also, it is desirable that the above-described high-frequency components correspond to the speakers disposed in a narrow range, and the above-described low-frequency components correspond to the speakers disposed in a wide range. Thus, it is possible to simultaneously adjust the width of the directivity and the output level for each frequency component.

### BRIEF DESCRIPTION OF THE DRAWINGS

FIG. 1 is a diagram illustrating a configuration of a speaker system according to an embodiment of the present disclosure;

FIG. 2 is a diagram illustrating an example of a speaker array;

FIG. 3 is a diagram illustrating a positional relationship between the speaker array and listeners;

FIG. 4 is a diagram illustrating a relationship between frequency bands and speakers;

FIG. 5 is a diagram illustrating a relationship between frequency bands and speakers;

FIG. 6 is a diagram illustrating a relationship between frequency bands and speakers;

FIG. 7 is a diagram illustrating a relationship between frequency bands and speakers;

FIG. 8 is a diagram illustrating a configuration of a speaker system according to a modified example;

FIG. 9 is a diagram illustrating a configuration of a speaker system according to another modified example;

FIG. 10 is a diagram illustrating another example in which the number of speakers is varied with frequency bands;

FIG. 11 is a diagram illustrating another example in which the number of speakers is varied with frequency bands;

FIG. 12 is a diagram illustrating another example in which the number of speakers is varied with frequency bands;

FIG. 13 is a diagram illustrating another example in which the number of speakers is varied with frequency bands;

FIG. 14A is a diagram illustrating another example in which the number of speakers is varied with frequency bands;

FIG. 14B is a diagram illustrating another example in which the number of speakers is varied with frequency bands;

FIG. 14C is a diagram illustrating another example in which the number of speakers is varied with frequency bands; and

FIG. 14D is a diagram illustrating another example in which the number of speakers is varied with frequency bands.

### DETAILED DESCRIPTION

Hereinafter, a speaker system according to an embodiment of the present disclosure will be described with reference to the drawings.

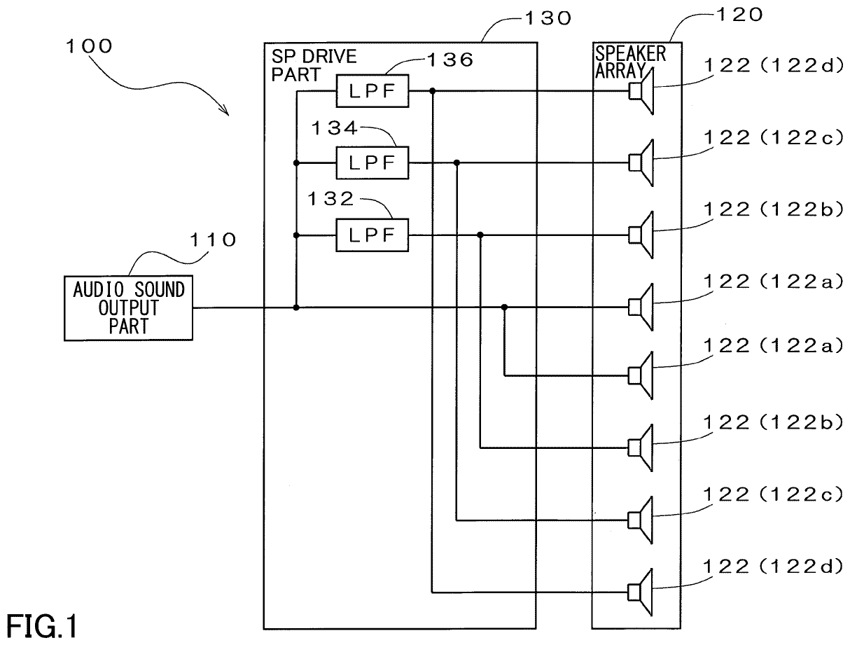

FIG. 1 is a diagram illustrating a configuration of the speaker system according to the embodiment. A speaker system 100 illustrated in FIG. 1 is configured to emit a sound corresponding to an audio sound signal to be input, to a plurality of listeners located in specific areas. To do this, the speaker system 100 includes an audio sound output part 110, a speaker array 120, and a speaker (SP) drive part 130. The audio sound output part 110 corresponds to the output sound generator, and the SP drive part 130 corresponds to the speaker driver. Note that the output sound generator and the speaker driver are each an electronic circuit, such as a central processing unit (CPU), a field programmable gate array (FPGA), an application specific integrated circuit (ASIC), or the like, and are configured to execute various processes described in the present specification by executing instruction codes stored in a memory or by being designed as a circuit for specific applications.

The audio sound output part 110 is configured to output audio sound signals to be emitted to a plurality of listeners. The output sound is assumed to be, for example, an output sound in receivers of terrestrial digital broadcasting, satellite broadcasting, and the like. The output sound may be, for example, an output sound of a video image distributed on the Internet, or an output sound without a video image, e.g., an output sound obtained by reproducing an audio sound recorded in a compact disc (CD), a semiconductor memory, or the like.

The speaker array 120 includes a plurality of speakers 122 to which frequency components included in audio sound signals output from the audio sound output part 110 are selectively input. The speaker array 120 is disposed at a position facing a plurality of listeners.

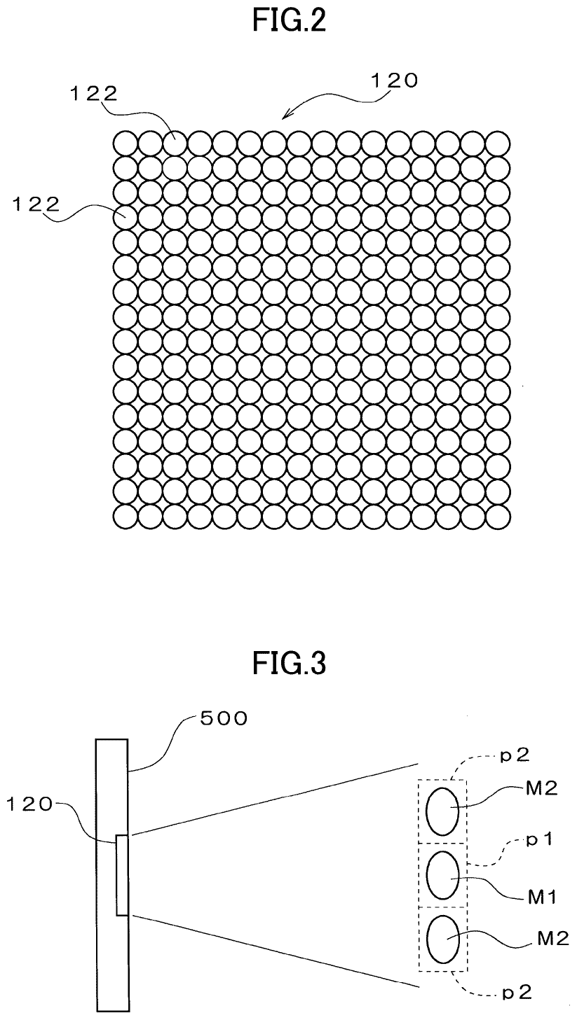

FIG. 2 is a diagram illustrating an example of the speaker array 120. As illustrated in FIG. 2, the speaker array 120 of the present embodiment includes a total of two hundred and fifty-six speakers 122 (sixteen vertical rows by sixteen horizontal rows) that are disposed without gaps.

By emitting an audio sound from the speaker array 120 formed by the plurality of speakers 122 as illustrated in FIG. 2, it is possible to narrow directivity of the emitted sound. As a result, only the listeners positioned frontward of the speaker array 120 hear the audio sound, and it is possible to prevent an unnecessary audio sound from reaching any third person positioned at any other position.

FIG. 3 is a diagram illustrating a positional relationship between the speaker array 120 and listeners. In the example illustrated in FIG. 3, it is assumed that the speaker array 120 is disposed at a part of a display device 500 included in a receiver of terrestrial digital broadcasting, and an audio sound is provided to a listener M1 located in a predetermined area p1 facing the display device 500 and listeners M2 located in areas p2 next to the predetermined area p1. Because the directivity of the emitted sound can be narrowed by using the speaker array 120, the emitted sound (audio sound) can be heard by the listeners M1 and M2 located in the areas p1 and p2.

The width of the directional characteristic of the sound emitted from the speaker array 120 depends on the number of the speakers 122 forming the speaker array 120 (spatial divergence) and on the frequency of the emitted sound. In general, the smaller the number of the speakers 122 forming the speaker array 120 (the narrower the spatial divergence), the wider the directivity. In contrast, the larger the number of the speakers 122 forming the speaker array 120 (the wider the spatial divergence), the narrower the directivity. Also, the higher the frequency of the emitted sound, the narrower the directivity. In contrast, the lower the frequency of the emitted sound, the wider the directivity.

For this reason, low-frequency components of the emitted sound can sufficiently reach the three listeners M1 and M2 located in the areas p1 and p2 illustrated in FIG. 3, whereas high-frequency components of the emitted sound can be heard only by the listener M1 located at the center. As a result, the listeners M2 next to the listener M1 have trouble hearing the high-frequency components of the emitted sound.

Therefore, in the present embodiment, an audio sound is emitted by use of all (two hundred and fifty-six) speakers 122 forming the speaker array 120 for the low-frequency components, whereas the number of the speakers 122 emitting the audio sound is reduced (the spatial divergence is narrowed) as the frequency becomes higher.

Specifically, in the present embodiment, the number of the speakers 122 emitting the audio sound is changed for four frequency bands, i.e., 500 Hz or lower, 1 kHz or lower, 2 kHz or lower, and 4 kHz or lower.

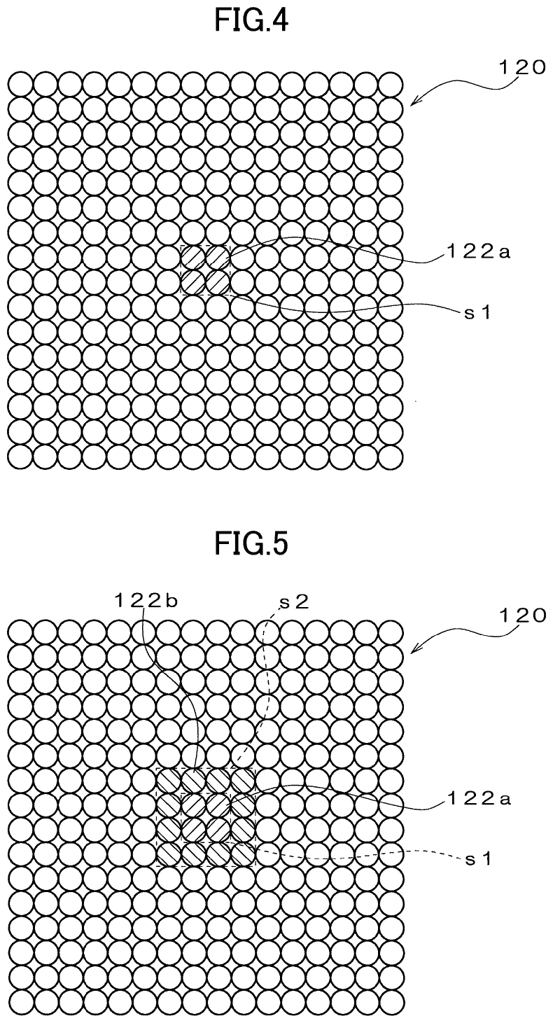

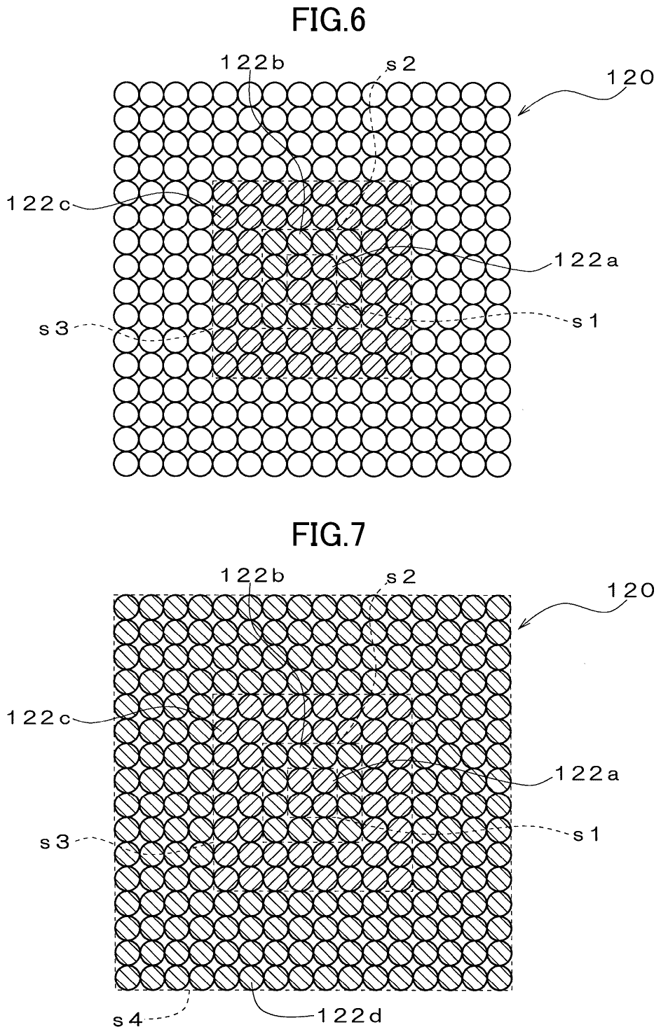

FIGS. 4 to 7 are diagrams illustrating the relationship between the frequency bands and the speakers 122. Assuming that a frequency band of 4 kHz or lower is changed in four steps, four regions are set in the speaker array 120. A region s1 (FIG. 4), which includes a total of four of the speakers 122 (122a) that are disposed to be the closest to the center in an arrangement of two vertical rows by two horizontal rows, corresponds to the highest frequency band (2 kHz or higher). The region s1 and a region s2 of one row enclosing the region s1 (FIG. 5), which include a total of sixteen of the speakers 122 (122a and 122b), correspond to the second highest frequency band (1 kHz or higher). The region s2 and a region s3 of two rows enclosing the region s2 (FIG. 6), which include a total of sixty-four of the speakers 122 (122a, 122b, and 122c), correspond to the third highest frequency band (500 Hz or higher). The region s3 and a region s4 of four rows enclosing the region s3 (FIG. 7), which include a total of two hundred and fifty-six of the speakers 122 (122a, 122b, 122c, and 122d), correspond to all of the frequency bands including the lowest frequency band. In this manner, when the frequency is doubled, it is possible to approximately equalize the width of the directivity of the emitted sound corresponding to each frequency band by narrowing, by a factor of ½, the region in which the speakers 122 are disposed.

The SP drive part 130 is configured to extract, and amplify, four different frequency components from audio sound signals output from the audio sound output part 110, and input the amplified signals to corresponding ones of the speakers 122 (122a to 122d) in the speaker array 120, thereby driving each of the speakers 122.

To do this, the SP drive part 130 includes three low pass filters (LPFs) 132, 134, and 136. The LPF 132 is set to a cutoff frequency of 2 kHz, and extracts a signal of a frequency component lower than 2 kHz from among audio sound signals. The LPF 134 is set to a cutoff frequency of 1 kHz, and extracts a signal of a frequency component lower than 1 kHz from among audio sound signals. The LPF 136 is set to a cutoff frequency of 500 Hz, and extracts a signal of a frequency component lower than 500 Hz from among audio sound signals.

When an audio sound signal is input to the SP drive part 130 having such a configuration, the SP drive part 130 inputs the audio sound signal itself to the speakers 122a (FIG. 4); inputs a signal of a frequency component of 2 kHz or lower to the speakers 122a and 122b (FIG. 5); inputs a signal of a frequency component of 1 kHz or lower to the speakers 122a, 122b, and 122c (FIG. 6); and inputs a signal of a frequency component of 500 Hz or lower to the speakers 122a, 122b, 122c, and 122d (FIG. 7), thereby driving each of the speakers 122 included in the speaker array 120. Although an amplifier configured to amplify the signal and drive each of the speakers 122 is included in front of each of the speakers 122, such an amplifier is omitted in FIG. 1. The above is described as follows in terms of frequency bands.

(1a) The signal of a frequency component of 500 Hz or lower included in the audio sound is directly input to the speakers 122a, and also extracted through the LPFs 132, 134, and 136 and input to the speakers 122b, 122c, and 122d. That is, the signal of a frequency component of 500 Hz or lower is input to all of the speakers 122 included in the region s4 of the speaker array 120. In this manner, the sound of the frequency component emitted from the speakers 122a to 122d is set to have a range of directivity so as to reach the three listeners M1 and M2 located in the areas p1 and p2 illustrated in FIG. 3.

(2a) The signal of a frequency component of 500 Hz to 1 kHz included in the audio sound is directly input to speakers 122a, and also extracted through the LPFs 132 and 134 and input to the speakers 122b and 122c. That is, the signal of a frequency component of 500 Hz to 1 kHz is input only to the speakers 122a, 122b, and 122c included in the region s3, which is closer to the center of the speaker array 120. In this manner, the sounds of frequency components emitted from some of the speakers, i.e., the speakers 122a to 122c, have frequencies that are higher than that of the frequency component of 500 Hz or lower, and thus the directivity of the emitted sounds becomes narrower. However, by commensurately reducing the range including the speakers that emit the sounds, i.e., to the range including the speakers 122a, 122b, and 122c, the range of directivity equivalent to that in the above-described case (1a) is ensured.

(3a) The signal of a frequency component of 1 kHz to 2 kHz included in the audio sound is directly input to the speakers 122a, and also extracted through the LPF 132 and input to the speakers 122b. That is, the signal of a frequency component of 1 kHz to 2 kHz is input only to the speakers 122a and 122b included in the region s2, which is even closer to the center of the speaker array 120. In this manner, the sounds of frequency components emitted from some of the speakers, i.e., the speakers 122a and 122b, have frequencies that are higher than that of the frequency component of 1 kHz or lower, and thus the directivity of the emitted sounds becomes even narrower. However, by commensurately reducing the range including the speakers that emit the sounds, i.e., to the range including the speakers 122a and 122b, the range of directivity equivalent to that in the above-described cases (1a) and (2a) is ensured.

(4a) The signal of a frequency component of 2 kHz or higher included in the audio sound is directly input to the speakers 122a, but cannot pass through the LPFs 132, 134, and 136. That is, the signal of a frequency component of 2 kHz or higher is input only to the speakers 122a included in the region s1, which is the closest to the center of the speaker array 120. In this manner, the sounds of frequency components emitted from some of the speakers, i.e., the speakers 122a, have frequencies that are higher than that of the frequency component of 2 kHz or lower, and thus the directivity of the emitted sounds becomes even narrower. However, by commensurately reducing the range including the speakers that emit the sounds, i.e., to the range including the speakers 122a, the range of directivity equivalent to that in the above-described cases (1a), (2a), and (3a) is ensured.

As described above, according to the speaker system 100 of the present embodiment, by switching the speakers 122 to be driven for each frequency band, it is possible to widen the directivity of the emitted sounds, which becomes narrower as the frequency becomes higher in the case of being emitted from the same number of the speakers 122. Thus, all of the plurality of listeners M1 and M2 located at specific places (the predetermined areas p1 and p2) can hear a sound in a wide frequency range, i.e., a low-frequency sound to a high-frequency sound. In particular, by varying the range in which the speakers 122 are disposed and the number of the speakers 122 for each frequency band, it is possible to desirably set the width of the directivity for each frequency band.

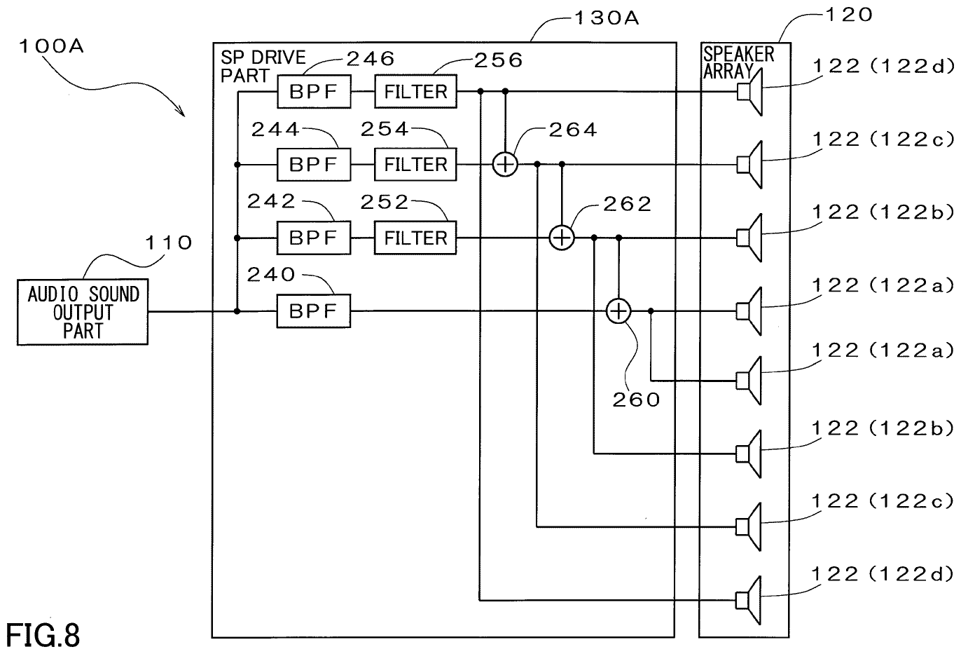

FIG. 8 is a diagram illustrating a configuration of a speaker system according to a modified example. A speaker system 100A illustrated in FIG. 8 is different from the speaker system 100 illustrated in FIG. 1 in that the SP drive part 130 is replaced with an SP drive part 130A.

The SP drive part 130A is configured to extract four different frequency components from audio sound signals output from the audio sound output part 110, followed by gain adjustment and then amplification, and input the amplified signals to corresponding ones of the speakers 122 (122a to 122d) in the speaker array 120, thereby driving each of the speakers 122.

To do this, the SP drive part 130A includes four band pass filters (BPFs) 240, 242, 244, and 246, three gain adjustment filters 252, 254, and 256, and three adders 260, 262, and 264. The filters 252, 254, and 256 correspond to the gain adjuster.

The BPF 240 extracts components in a frequency band of 2 kHz or higher from among audio sound signals. The BPF 242 extracts components in a frequency band of 1 kHz to 2 kHz from among audio sound signals. The BPF 244 extracts components in a frequency band of 500 Hz to 1 kHz from among audio sound signals. The BPF 246 extracts components in a frequency band of 500 Hz or lower from among audio sound signals.

The filter 252 performs gain adjustment at gain g1 on the components in a frequency band of 1 kHz to 2 kHz output from the BPF 242. The filter 254 performs gain adjustment at gain g2 on the components in a frequency band of 500 Hz to 1 kHz output from the BPF 244. The filter 256 performs gain adjustment at gain g3 on the components in a frequency band of 500 Hz or lower output from the BPF 246. Signals after these gain adjustments are input to the speakers 122d (FIG. 7) and the adder 264.

According to the speaker system 100 illustrated in FIG. 1, the number of the speakers 122 corresponding to each frequency band is not the same, i.e., the lower the frequency band, the larger the number of speakers 122 that emit sounds, and the higher the frequency band, the smaller the number of speakers 122 that emit sounds. As a result, a difference arises in the output level in each frequency band. This modified example is improved in this matter such that the respective gains of the filters 252, 254, and 256 are in a relationship of g1>g2>g3, i.e., the degree of signal attenuation increases in the order of the filters 252, 254, and 256. This eliminates a difference in the output level in each frequency band.

The adder 264 adds the signal in the frequency band of 500 Hz or lower output from the BPF 246 after the gain adjustment performed by the filter 256, and the signal in the frequency band of 500 Hz to 1 kHz output from the BPF 244 after the gain adjustment performed by the filter 254. The added signal is input to the speakers 122c (FIG. 6) and the adder 262.

The adder 262 adds the signal in a frequency band of 1 kHz or lower after the gain adjustment output from the adder 264, and the signal in a frequency band of 1 kHz to 2 kHz output from the BPF 242 after the gain adjustment performed by the filter 252. The added signal is input to the speakers 122b (FIG. 5) and the adder 260.

The adder 260 adds the signal in a frequency band of 2 kHz or lower after the gain adjustment output from the adder 262, and the components in a frequency band of 2 kHz or higher output from the BPF 240. The added signal is input to the speakers 122a (FIG. 4).

When an audio sound signal is input to the SP drive part 130A having such a configuration, the SP drive part 130A inputs, to the speakers 122a (FIG. 4), a signal obtained after the gain adjustment of the components in all frequencies included in the input audio sound signal; inputs, to the speakers 122a and 122b (FIG. 5), a signal obtained after the gain adjustment of each frequency component of 2 kHz or lower; inputs, to the speakers 122a, 122b, and 122c (FIG. 6), a signal obtained after the gain adjustment of each frequency component of 1 kHz or lower; and inputs, to the speakers 122a, 122b, 122c, and 122d (FIG. 7), a signal obtained after the gain adjustment of each frequency component of 500 Hz or lower, thereby driving each of the speakers 122 included in the speaker array 120. Although an amplifier configured to amplify the signal and drive each of the speakers 122 is included in front of each of the speakers 122, such an amplifier is omitted in FIG. 8. The above is described as follows in terms of frequency bands.

(1b) The signal of a frequency component of 500 Hz or lower included in the audio sound is extracted through the BPF 264, and further subjected to gain adjustment through the filter 256 and then input to the speakers 122a to 122d. That is, the signal of a frequency component of 500 Hz or lower is input to all of the speakers 122 included in the region s4 of the speaker array 120 after the gain adjustment for each frequency band. In this manner, the sound of the frequency component emitted from the speakers 122a to 122d is set to have a range of directivity so as to reach the three listeners M1 and M2 located in the areas p1 and p2 illustrated in FIG. 3.

(2b) The signal of a frequency component of 500 Hz to 1 kHz included in the audio sound is extracted through the BPF 244, and further subjected to gain adjustment through the filter 254 and then input to the speakers 122a to 122c. That is, the signal of a frequency component of 500 Hz to 1 kHz is, after gain adjustment for each frequency band, input only to the speakers 122a, 122b, and 122c included in the region s3, which is closer to the center of the speaker array 120. In this manner, the sounds of frequency components emitted from some of the speakers, i.e., the speakers 122a to 122c, have frequencies that are higher than that of the frequency component of 500 Hz or lower, and thus the directivity of the emitted sounds becomes narrower. However, by commensurately reducing the range of the speakers that emit the sounds, i.e., to the range including the speakers 122a, 122b, and 122c, the range of directivity equivalent to that in the above-described case (1b) is ensured.

(3b) The signal of a frequency component of 1 kHz to 2 kHz included in the audio sound is extracted through the BPF 242, and further subjected to gain adjustment through the filter 252 and then input to the speakers 122a and 122b. That is, the signal of a frequency component of 1 kHz to 2 kHz is, after gain adjustment for each frequency band, input only to the speakers 122a and 122b included in the region s2, which is even closer to the center of the speaker array 120. In this manner, the sounds of frequency components emitted from some of the speakers, i.e., the speakers 122a and 122b, have frequencies that are higher than that of the frequency component of 1 kHz or lower, and thus the directivity of the emitted sounds becomes narrower. However, by commensurately reducing the range of the speakers that emit the sounds, i.e., to the range including the speakers 122a and 122b, the range of directivity equivalent to that in the above-described cases (1b) and (2b) is ensured.

(4b) The signal of a frequency component of 2 kHz or higher included in the audio sound is directly input to the speakers 122a. That is, the signal of a frequency component of 2 kHz or higher is input only to the speakers 122a included in the region s1, which is the closest to the center of the speaker array 120. In this manner, the sounds of frequency components emitted from some of the speakers, i.e., the speakers 122a, have frequencies that are higher than that of the frequency component of 2 kHz or lower, and thus the directivity of the emitted sounds becomes even narrower. However, by commensurately reducing the range of the speakers that emit the sounds, i.e., to the range including the speakers 122a, the range of directivity equivalent to that in the above-described cases (1b), (2b), and (3b) is ensured.

As described above, according to the speaker system 100A of this modified example, gain adjustment for each frequency band is performed by using the filters 252, 254, and 256. Thus, when a sound is emitted from different numbers of the speakers 122 corresponding to each frequency component, it is possible to eliminate the difference in the output level for each frequency component.

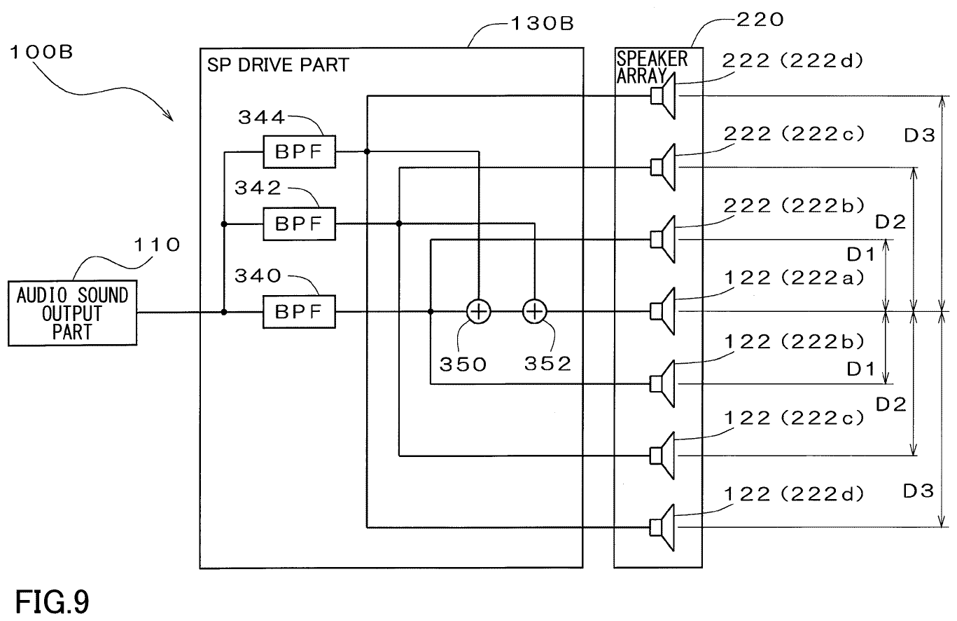

FIG. 9 is a diagram illustrating a configuration of a speaker system according to another modified example. A speaker system 100B illustrated in FIG. 9 is different from the speaker system 100 illustrated in FIG. 1 in that the SP drive part 130 is replaced with an SP drive part 130B and the speaker array 120 is replaced with a speaker array 220.

The SP drive part 130B is configured to extract, and amplify, three different frequency components from audio sound signals output from the audio sound output part 110, and input the amplified signals to corresponding speakers 222 (222a, 222b, 222c, and 222d) in the speaker array 220, thereby driving each of the speakers 222.

To do this, the SP drive part 130B includes three band pass filters (BPFs) 340, 342, and 344, and two adders 350 and 352.

The BPF 340 extracts a high-frequency component from among audio sound signals. The signal of the high-frequency component is input to the speakers 222b, included in the speaker array 220, and the adder 350. The BPF 342 extracts a middle-frequency component from among audio sound signals. The signal of the middle-frequency component is input to the speakers 222c, included in the speaker array 220, and the adder 352. The BPF 344 extracts a low-frequency component from among audio sound signals. The signal of the low-frequency component is input to the speakers 222d, included in the speaker array 220, and the adder 350.

The adder 350 adds the signal of the high-frequency component output from the BPF 340, and the signal of the low-frequency component output from the BPF 344. The added signal is input to the adder 352. The adder 352 adds a signal output from the adder 350 (a signal including the high-frequency component and the low-frequency component), and the signal of the middle-frequency component output from the BPF 342. The added signal is input to the speaker 222a included in the speaker array 220.

When an audio sound signal is input to the SP drive part 130B having such a configuration, the SP drive part 130B extracts a high-frequency component, included in the input audio sound signal, through the BPF 340, and inputs the extracted high-frequency component to the speakers 222a and 222b directly or through the adders 350 and 352; extracts a middle-frequency component, included in the input audio sound signal, through the BPF 342, and inputs the extracted middle-frequency component to the speakers 222a and 222c directly or through the adder 352; and extracts a low-frequency component, included in the input audio sound signal, through the BPF 344, and inputs the extracted low-frequency component to the speakers 222a and 222d directly or through the adder 350, thereby driving each of the speakers 222 included in the speaker array 220. Although an amplifier configured to amplify the signal and drive each of the speakers 222 is included in front of each of the speakers 222, such an amplifier is omitted in FIG. 9. The above is described as follows in terms of frequency bands.

(1c) The signal of the low-frequency component included in the audio sound is input to the speakers 222d and 222a of the speaker array 220.

In this modified example, the speaker array 220 includes: the speaker 222a disposed at the center; the speakers 222b each disposed at a position next to the speaker 222a (at a distance D1 from the speaker 222a disposed at the center); the speakers 222c each disposed at a position outward of the speaker 222b (at a distance D2 (>D1) from the speaker 222a disposed at the center); and the speakers 222d each disposed at a position outward of the speaker 222c (at a distance D3 (>D2) from the speaker 222a disposed at the center).

According to the speaker array 220, the signal of the low-frequency component is input to the speaker 222a disposed at the center, and the outermost speakers 222d disposed at both ends. In this manner, the sound of the low-frequency component emitted from the speakers 222a and 222d, which are disposed so as to have the largest distance therebetween, is set to have a range of directivity so as to reach the three listeners M1 and M2 located in the areas p1 and p2 illustrated in FIG. 3.

(2c) The signal of the middle-frequency component included in the audio sound is input to the speakers 222c and 222a of the speaker array 220. The sound of the middle-frequency component emitted from these speakers 222a and 222c has narrower directivity as the emitted sound because the frequency is higher than that of the sound of the low-frequency component. However, by commensurately reducing the range including the speakers that emit the sounds, i.e., to the range including the speakers 222a and 222c, the range of directivity equivalent to that in the above-described case (1c) is ensured.

(3c) The signal of the high-frequency component included in the audio sound is input to the speakers 222b and 222a of the speaker array 220. The sound of the high-frequency component emitted from these speakers 222a and 222b has even narrower directivity as the emitted sound because the frequency is even higher than that of the sound of the middle-frequency component. However, by commensurately reducing the range including the speakers that emit the sounds, i.e., to the range including the speakers 222a and 222b, the range of directivity equivalent to that in the above-described case (1c) and (2c) is ensured.

In this modified example, the number of the speakers 222 that emit the sound of each frequency band can be made the same in all of the cases (1c) to (3c) described above. Therefore, the difference in the output level when emitting the sound of each frequency band is eliminated without using, for example, the filters 252, 254, and 256 illustrated in FIG. 8.

The present disclosure is not limited to the above-described embodiments, and various modifications can be made within the scope of the present disclosure. In the speaker array 120 illustrated in FIGS. 4 to 7, the number of the speakers 122 located vertically and horizontally is varied in accordance with the frequency components of an audio sound. However, as illustrated in FIG. 3, when changing the directivity of each frequency component of the emitted sound in one direction (horizontal direction), the number of speakers may be varied in accordance with that direction.

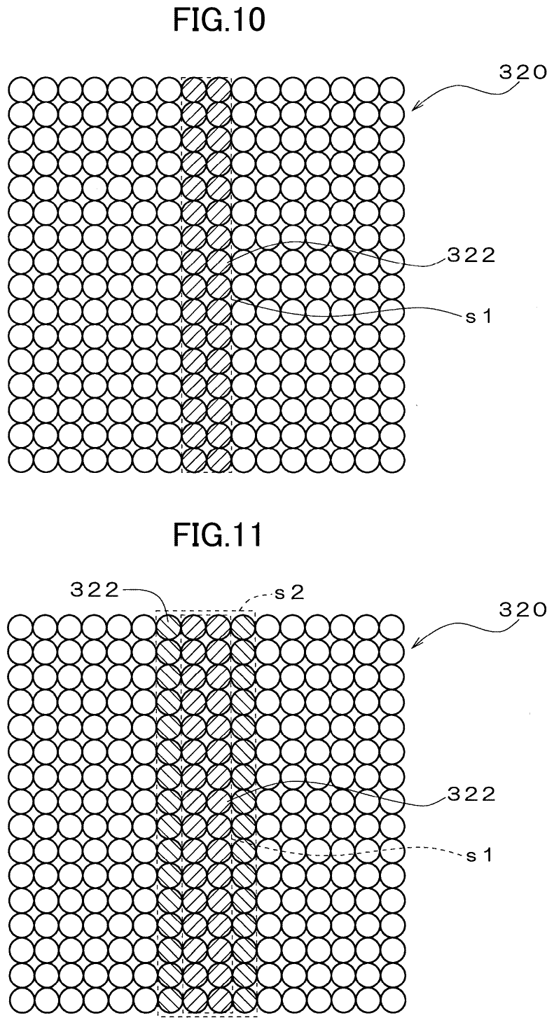

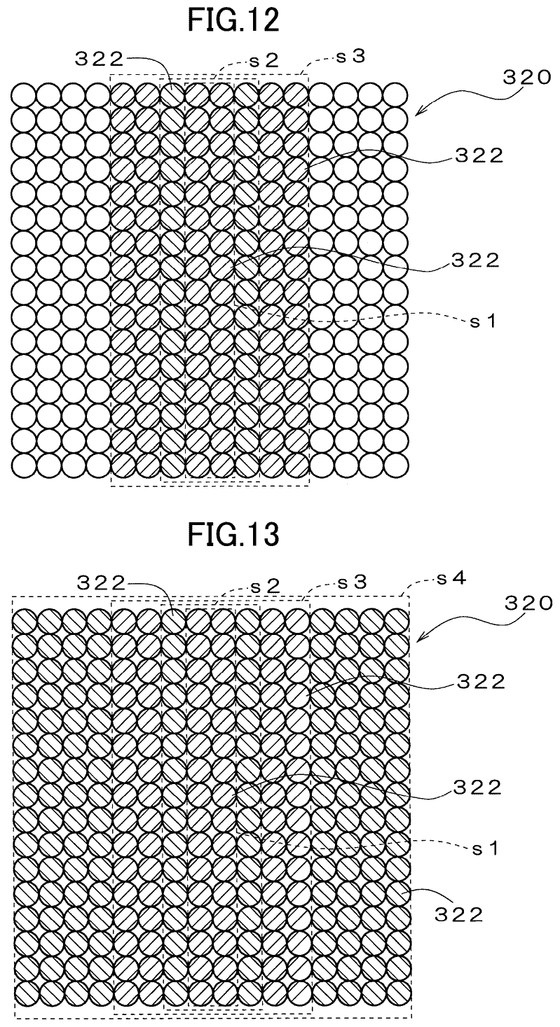

FIGS. 10 to 13 are diagrams illustrating another example in which the number of speakers is varied with frequency bands. In the same manner as in the example illustrated in FIG. 4, four regions are set in a speaker array 320 assuming that a frequency band of 4 kHz or lower is divided into four. A region s1 (FIG. 10), which includes a total of thirty-two speakers 322 that are disposed in two vertical rows the closest to the center, corresponds to the highest frequency band (2 kHz or higher). The region s1 and a region s2 of one left row and one right row sandwiching the region s1 (FIG. 11), which include a total of sixty-four of the speakers 322, correspond to the second highest frequency band (1 kHz to 2 kHz). The region s2 and a region s3 of two left rows and two right rows sandwiching the region s2 (FIG. 12), which include a total of one hundred and twenty-eight of the speakers 322, correspond to the third highest frequency band (500 Hz to 1 kHz). The region s3 and a region s4 of four left rows and four right rows sandwiching the region s3 (FIG. 13), which include a total of two hundred and fifty-six of the speakers 322, correspond to all of the frequency bands including the lowest frequency band. In this manner, when the frequency is doubled, it is possible to approximately equalize the width of the horizontal directivity of the emitted sound corresponding to each frequency band by narrowing, by a factor of ½, the horizontal region in which the speakers 322 are disposed.

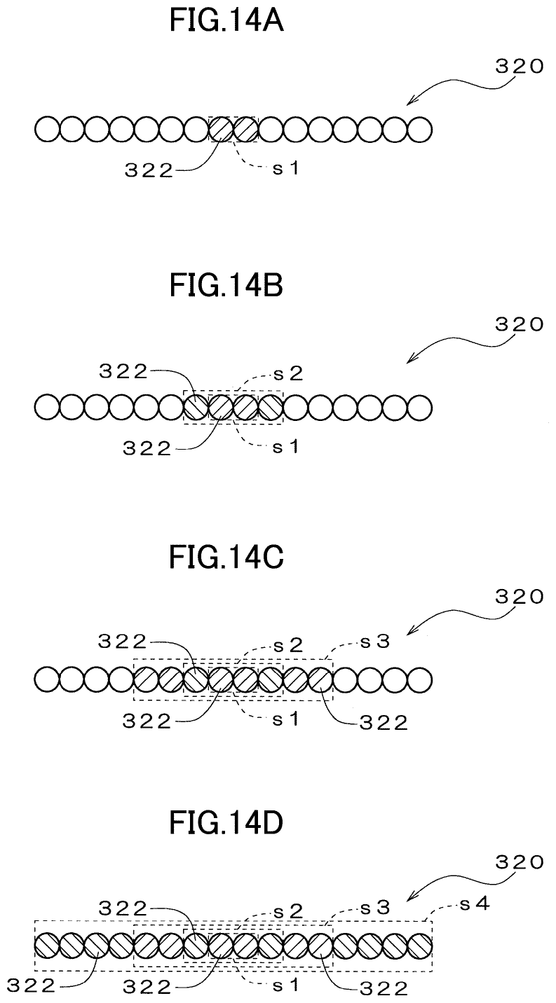

FIGS. 14A to 14D are diagrams illustrating another example in which the number of speakers is varied with frequency bands. Although the speaker array 320 is formed by a total of two hundred and fifty-six of the speakers 322 that are disposed in an arrangement of sixteen vertical rows by sixteen horizontal rows in the example illustrated in FIGS. 10 to 13, the number of the speakers 322 disposed in the vertical direction may be changed, for example. According to the examples illustrated in FIGS. 14A to 14D, the speaker array 320 is formed by the speakers 322 disposed in one vertical row (sixteen speakers). The frequency bands corresponding to FIGS. 14A, 14B, 14C, and 14D are the same as the frequency bands corresponding to FIGS. 10, 11, 12, and 13.

Although the number of the speakers 222 corresponding to each frequency component is made the same in the modified example illustrated in FIG. 9, the number of the speakers 222 corresponding to each frequency component does not necessarily need to be made the same. In this case, gain adjustment performed as in the speaker system 100A illustrated in FIG. 8 may be performed in accordance with the difference in the number of the speakers.

As described above, according to the present disclosure, by performing switching between different speakers to be driven for each frequency component, it is possible to widen directivity of emitted sounds, which becomes narrower as the frequency becomes higher in the case of being emitted from the same speaker. Thus, a plurality of listeners located at specific places can hear sounds in a wide frequency range, i.e., a low-frequency sound to a high-frequency sound.

What is claimed is:

1. A speaker system, comprising:
an output sound generator configured to output a sound to be output;
a speaker array that includes a plurality of speakers; and
a speaker driver configured to extract a plurality of frequency components having different frequencies from the sound that is output from the output sound generator, and selectively drive one or more of the plurality of speakers in accordance with signals of the plurality of frequency components, wherein
the speaker driver is configured to input the plurality of frequency components to the one or more of the plurality of speakers in accordance with widths of directivity of the plurality of frequency components.

2. The speaker system according to claim 1, wherein
the frequency components that have a high frequency correspond to one or more of the speakers disposed in a narrow range, and the frequency components that have a low frequency correspond to two or more of the speakers disposed in a wide range.

3. The speaker system according to claim 2, wherein
the frequency components that have a high frequency correspond to a first number of the speakers disposed in the narrow range, and the frequency components that have a low frequency correspond to a second number of the speakers disposed in the wide range,
the second number being greater than the first number.

4. The speaker system according to claim 1, further comprising:
a gain adjuster configured to adjust an output level of the speaker array in accordance with at least a part of the plurality of frequency components.

5. The speaker system according to claim 1, wherein
the speakers are same in number for each of the plurality of frequency components.

6. The speaker system according to claim 5, wherein
the frequency components that have a high frequency correspond to the speakers disposed in a narrow range, and the frequency components that have a low frequency correspond to the speakers disposed in a wide range.
